(19) United States
(12) Patent Application Publication
(10) Pub. No.: US 2014/0219641 A1
(43) Pub. Date: Aug. 7, 2014

(54) CERAMIC ROD AND AUXILIARY HEATER OR LIQUID HEATER COMPRISING A CERAMIC HEATING ROD

(71) Applicant: BorgWarner BERU Systems GmbH, Ludwigsburg (DE)

(72) Inventors: Alexander Dauth, Maulbronn (DE); Rüdiger Hanf, Oberderdingen (DE)

(21) Appl. No.: 14/172,541

(22) Filed: Feb. 4, 2014

(30) Foreign Application Priority Data
Feb. 6, 2013 (DE) 10 2013 101 174.8

(51) Int. Cl. B60H 1/22; H05B 1/02; H05B 3/48

(52) U.S. Cl. CPC B60H 1/2225; H05B 3/48; H05B 1/0236
USPC 392/347; 219/534; 219/544

(57) ABSTRACT

This disclosure relates to a ceramic rod having a ceramic PTC heating conductor and a ceramic insulation layer, which is sintered with the PTC heating conductor. According to this disclosure, the PTC heating conductor has a transition temperature that does not exceed 300° C., and preferably does not exceed 200° C. This disclosure also relates to the use of a ceramic rod, which comprises a ceramic PTC heating conductor and a ceramic insulation layer, which is sintered with the PTC heating conductor, as a heating rod for an auxiliary heater or a liquid heater in a motor vehicle. This disclosure also relates to an auxiliary heater for heating an air flow and a liquid heater comprising a heating rod, which is a ceramic rod, which has a ceramic PTC heating conductor and a ceramic insulator sintered therewith.

### RELATED APPLICATIONS

This application claims priority to DE 10 2013 101 174.8, filed Feb. 6, 2013, the entire disclosure of which is hereby incorporated herein by reference in its entirety.

### BACKGROUND

The invention relates to an auxiliary heater of a motor vehicle, as is known from DE 10 2008 003 867 A1, for example. Such auxiliary heaters comprise one or more heating rods, onto which heat-dissipation elements, typically sheet metal fins, are slid. The heating rods have a housing tube, in which at least one ceramic PTC heating conductor is disposed, which is connected to a power source via a contact plate, which protrudes from the housing tube.

Auxiliary heaters, which heat an air flow, are used to heat the interior of motor vehicles. In the case of highly fuel-efficient diesel engines, in particular, when frost occurs, the heat dissipated from the engine is insufficient to clear a coated windshield and heat the vehicle interior to a comfortable temperature within a short period of time.

### SUMMARY

The present invention provides a way in which auxiliary heaters for motor vehicles can be produced at lower cost.

The production of conventional heating rods comprising a housing tube, in which one or more PTC heating elements, a contact plate and insulation material are disposed, is substantially more complex than the production of a ceramic rod. A ceramic rod, which comprises a PTC heating conductor and an insulation layer sintered with the PTC heating conductor, can be produced by coextrusion and sintering of a green body, for example. Heat-dissipating elements, such as sheet metal fins, for example, can be slid onto such a ceramic rod, thereby producing an auxiliary heater in a relatively simple manner.

The present invention also relates to a liquid heater. A ceramic rod can also be used in a motor vehicle for a low-cost liquid heater, for example to heat water for windshield cleaning, or to heat fuel.

Ceramic PTC heating conductors can be produced on the basis of barium titanate or other ferroelectric materials, for example. The electrical resistance of such PTC heating conductors increases at a transition temperature by several orders of magnitude, for example ten-fold, one hundred-fold, or more. Such ceramic PTC heating conductors therefore comprise an intrinsic safeguard against overheating. PTC heating conductors having a transition temperature that does not exceed 300° C., and preferably does not exceed 200° C., are particularly well suited for auxiliary heaters and liquid heaters of motor vehicles.

As an alternative to ferroelectric PTC heating conductors, the electrical resistance of which can increase drastically at a transition temperature, it is also possible to use ceramic PTC heating conductors, the electrical resistance of which does not undergo an abrupt increase. Molybdenum silicide, for example, is a PTC heating conductor having an electrical resistance that increases across broad temperature ranges without increasing abruptly.

### BRIEF DESCRIPTION OF THE DRAWINGS

Further details and advantages of these teachings are explained using embodiments, with reference to the attached drawings. Components that are identical and correspond to one another are labelled therein using identical reference numerals. In the drawings:

FIG. 1 shows a schematic depiction of an auxiliary heater of a motor vehicle;

FIG. 2 shows a further view of FIG. 1;

FIG. 3 shows a detailed view of FIG. 1;

FIG. 4 shows a liquid heater for a motor vehicle;

FIG. 5 shows a longitudinal cross section of a ceramic pin;

FIG. 6 shows a cross section of FIG. 5;

FIG. 7 shows a longitudinal cross section of a further illustrative embodiment of a ceramic pin;

FIG. 8 shows a cross section of FIG. 7;

FIG. 9 shows a longitudinal cross section of a further illustrative embodiment of a ceramic pin; and

FIG. 10 shows a cross section of FIG. 9.

### DETAILED DESCRIPTION

The embodiments described below are not intended to be exhaustive or to limit the invention to the precise forms disclosed in the following detailed description. Rather, the embodiments are chosen and described so that others skilled in the art may appreciate and understand the principles and practices of this disclosure.

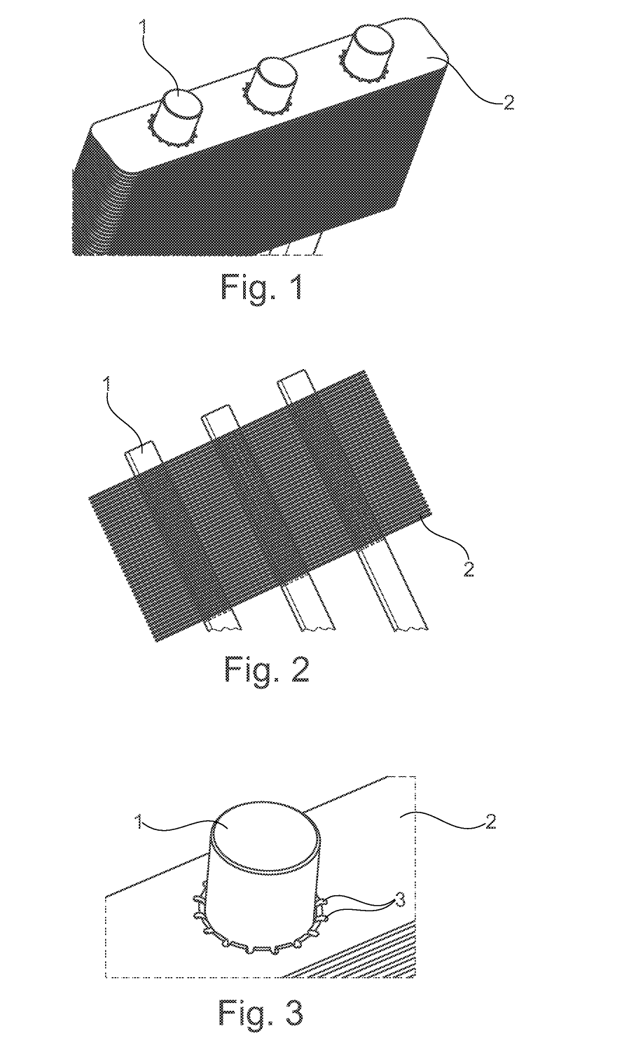

The auxiliary heater shown in FIGS. 1 to 3 is used to heat an air flow for heating the passenger compartment of a motor vehicle. The auxiliary heater comprises a plurality of heating rods 1, on which heat-dissipating elements 2 are attached. The heat-dissipating elements 2 can be designed as sheet metal fins, for example, which are slid onto the heating rods 1. The heating rods 1 are held in openings of the heat-dissipating elements 2, the edges of which have radially extending indentations 3. When the heat-dissipating elements 2 are slid onto the heating rods 1, edge sections of the heat-dissipating elements 2 are therefore bent and then bear resiliently against the heating rods 1, thereby resulting in good thermal contact.

The heating rods 1 are ceramic rods having a ceramic PTC heating conductor and a ceramic insulation layer, which is connected to the PTC heating conductor by sintering. Illustrative embodiments of heating rods are depicted in FIGS. 5 to 10.

The heating rod 1 shown in FIGS. 5 and 6 comprises a ceramic inner conductor 10, a ceramic insulation layer 11, which encloses the inner conductor 10, and a PTC heating conductor 12, which covers the insulation layer 11. The heating rod 1 comprises a ceramic conductive layer 13 on the end face, which electrically connects the inner conductor 10 to the PTC heating conductor 12. The heating rod 1 can taper at the end thereof remote from the conductive layer 13 in order to simplify connection to a power source.

The heating rod 1 can be manufactured by initially producing a green body by coextrusion of inner conductor material, insulation layer material, and PTC heating conductor material. Material for forming the conductive layer 13 is then applied onto an end face of the green body, for example as slip. The green body is then fired. Therein, the inner conductor 10, the insulation layer 11, the PTC heating conductor 12, and the conductive layer 13 are connected by sintering. If the heating rod should have a tapered end section, the green body can be machined accordingly in a shaping manner before sintering, or the ceramic rod can be machined accordingly in a shaping manner after sintering, for example by turning on a lathe.

The example shown in FIGS. 5 and 6 can be modified in that the inner conductor 10 and the PTC heating conductor 12 are interchanged.

A further illustrative embodiment of a heating rod 1 is shown in FIGS. 7 and 8. This heating rod 11 also comprises a ceramic inner conductor 10, a ceramic insulation layer 11, which encloses the inner conductor 10, a PTC heating conductor 12, which covers the insulation layer 11, and a conductive layer 13, which electrically connects the inner conductor 10 to the PCT heating conductor 12. In contrast to the heating rod shown in FIGS. 5 and 6, the heating rod shown in FIGS. 7 and 8 has a second insulation layer 14, which covers the PTC heating conductor 12. The second insulation layer 14 can also cover the conductive layer 13. Material for the second insulation layer 14 can be applied onto a green body as slip or using a dipping method, wherein the green body is then sintered.

The heating rod shown in FIGS. 7 and 8 is suitable, in particular, for high-voltage heaters, for example to operate supply voltages of greater than 60 V or even greater than 100 V. In the case of such high supply voltages, electrical insulation must be provided for all contacts, that is, the ground connection as well, for safety reasons. At lower supply voltages, e.g., in the range of 10 V to 30 V, the ground connection requires no insulation.

A further illustrative embodiment of a heating rod 1 is shown in FIGS. 9 and 10. This heating rod is a ceramic rod, which has an insulation layer 11, which encloses a PTC heating conductor 12 and is connected thereto via sintering. The heating rod can be tapered at both ends in order to simplify connection to a power source.

The heating rods of FIGS. 5 to 8 can be modified such that these are tapered at both ends, as shown in the example in FIGS. 9 and 10.

In the heating rods described, a ceramic on the basis of barium titanate can be used as the material for the PTC heating conductors 12, for example. The transition temperature of the PTC heating conductor is preferably no more than 300° C., for example no more than 200° C. A ceramic on the basis of silicon carbide or molybdenum silicide, for example, can be used for the inner conductor 10. A ceramic on the basis of silicon nitride or aluminum oxide, for example, can be used for the insulation layers 11, 14.

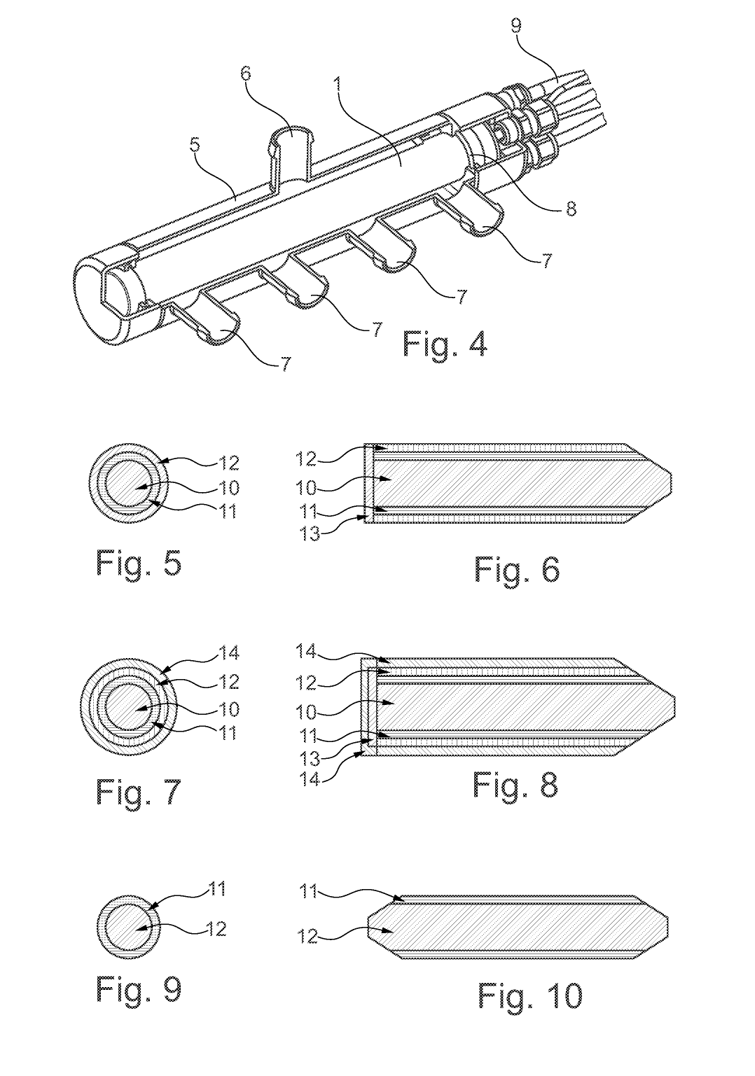

The above-described ceramic rods can be used as heating rods of auxiliary heaters to heat an air flow in motor vehicles, or as heating rods of liquid heaters in motor vehicles. An illustrative embodiment of a liquid heater having a ceramic rod as the heating rod is depicted in FIG. 4.

The liquid heater comprises a longitudinal housing 5, which has an inlet opening 6 for liquid to be heated, and a plurality of outlet openings 7 for heated liquid. The number of inlet openings 6 and outlet openings 7 can be varied depending on the intended use. For many applications, a single inlet opening 6 and a single outlet opening 7 are sufficient. The inlet openings 6 and the outlet openings 7 can be designed as bushes.

Liquid is heated using a heating rod 1 in the housing 5, which can be cylindrical, for example. The heating rod 1 is connected to a power source via lines 9 and is held in an insertion opening of the housing 5, which can be sealed by a sealing ring 8, for example an O-ring. The sealing ring 8 can be seated in an annular groove of the housing 5, although this sealing ring could also be seated in an annular groove of the heating rod 1. Liquid to be heated can flow around the heating rod 1 in the housing 5, whereby this heating rod gives off heat to the liquid.

While exemplary embodiments have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

### REFERENCE NUMERALS

1. heating rod
2. heat-dissipating elements
3. indentations
5. housing
6. inlet opening
7. outlet openings
8. sealing ring
9. lines
10. inner conductor
11. insulation layer
12. PTC heating conductor
13. conductive layer
14. second insulation layer

What is claimed is:

1. A ceramic rod, comprising:
a ceramic PTC heating conductor; and
a ceramic insulation layer sintered to the PTC heating conductor;
wherein the PTC heating conductor has a transition temperature that does not exceed 300° C.

2. The ceramic rod of claim 1, wherein the transition temperature of the PTC heating conductor does not exceed 200° C.

3. An auxiliary heater for heating an air flow in a motor vehicle, comprising:
at least one heating rod; and
heat-dissipating elements attached to the heating rod, wherein the heating rod is a ceramic rod, which comprises a ceramic PTC heating conductor and a ceramic insulator sintered to the ceramic PTC heating conductor.

4. The auxiliary heater according to claim 3, wherein the heat-dissipating elements are sheet metal fins, which have openings in which the heating rod is held.

5. The auxiliary heater according to claim 4, wherein the openings have an edge having radially outwardly extending indentations.

6. The auxiliary heater according to claim 5, wherein sheet metal sections between adjacent indentations are bent and bear resiliently against the heating rod.

7. The auxiliary heater according to claim 3, wherein the heating rod has a circular cross section.

8. The auxiliary heater according to claim 3, wherein the ceramic insulator covers the PTC heating conductor.

9. The auxiliary heater according to claim 3, wherein the heating rod comprises a ceramic inner conductor, and the ceramic insulator or one of the ceramic insulators is an insulation layer, which is disposed between the inner conductor and the PTC heating conductor.

10. A liquid heater for a motor vehicle, comprising:
a housing having at least one inlet opening for liquid to be heated and at least one outlet opening for heated liquid; and
at least one heating rod held in an insertion opening of the housing, wherein the heating rod is a ceramic rod comprising a ceramic PTC heating conductor and a ceramic insulator sintered to the ceramic PTC heating conductor.

11. The heater according to claim 10, wherein the heating rod has a circular cross section.

12. The heater according to claim 10, wherein the ceramic insulator covers the PTC heating conductor.

13. The heater according to claim 10, wherein the heating rod comprises a ceramic inner conductor, and the ceramic insulator or one of the ceramic insulators is an insulation layer, which is disposed between the inner conductor and the PTC heating conductor.
